(19) United States
(12) Patent Application Publication
(10) Pub. No.: US 2008/0281757 A1
(43) Pub. Date: Nov. 13, 2008

(54) TRUSTED PRIVACY INFORMATION MANAGEMENT

(75) Inventors: Soren Riise, Santa Clara, CA (US); Devesh Patel, Cupertino, CA (US); David Anthony Burgess, Menlo, CA (US); Christopher Bradley ZiCornell, San Mateo, CA (US); James William DelliSanti, Los Altos, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/756,947

(22) Filed: Jun. 1, 2007

Related U.S. Application Data
(63) Continuation-in-part of application No. 11/745,263, filed on May 7, 2007.

(51) Int. Cl. G06F 17/40; G06F 17/30; H04L 9/00

(52) U.S. Cl. 705/50; 707/104.1

(57) ABSTRACT

A method for tracking and controlling privacy information within a lead sales system includes logging receipt in a log of one or more encrypted leads by a trusted privacy information manager (TPIM) that are received from a participant thereof, the one or more leads including private lead information from a lead provider having been pre-processed and encrypted with a one-way hash algorithm; comparing the received one or more encrypted leads with stored encrypted leads to find matches; updating the log related to the one or more encrypted leads with information associated with the matching one or more encrypted leads, the log information including at least one of an e-mail address and a phone number of the lead provider; and communicating to the lead provider at least one way to access a user interface of the TPIM that enables the lead provider to control his or her private lead information.

### RELATED APPLICATIONS

This application claims the benefit of priority under 35 U.S.C. §120 to U.S. application Ser. No. 11/745,263, entitled “Trusted Third Party Clearing House For Lead Tracking” filed on May 7, 2007, which is hereby incorporated by reference in its entirety.

### BACKGROUND

1. Technical Field

The disclosed embodiments relate to a system and its methods for trusted privacy information management, and more particularly, to a sales lead tracking system that allows a lead provider to control his or her private lead information after submission.

2. Related Art

Before the Internet, advertisers sought to generate leads through the use of junk mail, or the collection of contact information from those who enter to win something free, like a car or a vacation. Additionally, there was the use of referral-based lead calling.

Since the establishment of the Internet, advertising models have consisted primarily of tracking impressions and clicks, which has been the predominate method for obtaining Internet traffic, e.g. with use of banner or search advertising. For instance, in traditional advertising business, advertisers have been using models such as Cost Per Impression (CPM) or Cost Per Click (CPC) as a means to generate traffic and encourage Internet (or web) users to connect to websites of a vendor. Spam e-mail and other forms of advertising have also been developed to entice consumers with free or reduced cost goods or services as a way to get more consumers to reach a vendor's website.

Once at a vendor website, an Internet user performs a transaction that is deemed the main purpose for the business of the website, such as supplying the details of a credit card application, signing up for a free newsletter, or some other similar activity. Private lead information of the user, or “lead provider,” may be gathered by the vendor or advertiser (which can be the same entity) and sold to a commercial consumer of leads, usually a consumer in the business related to the purpose of the lead provider's visit to the vendor's website. Currently, once a lead provider submits over the Internet his or her private lead information, such as name, address, phone number, social security number, etc., the lead provider loses control of how that information is handled, up to and including the extent to which it is resold as a lead.

### SUMMARY

By way of introduction, the embodiments described below include a system and methods for the management of trusted privacy information. The embodiments relate to a system and methods drawn to a sales lead tracking system that allows a lead provider to control his or her private lead information after submission.

In a first aspect, a method is disclosed for tracking and controlling privacy information within a lead sales system, including logging receipt in a log of one or more encrypted leads by a trusted privacy information manager (TPIM) that are received from a participant thereof, the one or more leads including private lead information from a lead provider having been pre-processed and encrypted with a one-way hash algorithm; comparing the received one or more encrypted leads with stored encrypted leads to find matches; updating the log related to the one or more encrypted leads with information associated with the matching one or more encrypted leads, the log information including at least one of an e-mail address and a phone number of the lead provider; and communicating to the lead provider at least one way to access a user interface of the TPIM that enables the lead provider to control his or her private lead information.

In a second aspect, a method is disclosed for tracking and controlling privacy information within a lead sales system, including submitting private lead information online by a lead provider to a participant of the lead sales system; receiving a communication from a trusted privacy information manager (TPIM) containing at least one way to access a user interface of the TPIM; accessing, through the TPIM user interface, logged information gathered by the TPIM, which includes at least an identification of a consumer that possesses, or has possessed, the private lead information; and selectively retracting the private lead information from the consumer.

In a third aspect, a trusted privacy information management (TPIM) server for tracking sales leads includes a network interface, to receive over a network, messages containing private lead information pre-processed and encrypted with a one-way hash algorithm, each message comprising at least one encrypted lead and unencrypted log information. A memory stores the encrypted leads together with a log in relation to each encrypted lead. A processor is in communication with the memory and the network interface, the processor operative in conjunction with stored data and instructions to implement a comparison module to compare received encrypted leads with stored encrypted leads, and a logging module to log receipt of the encrypted leads along with the associated log information. If an encrypted lead has a match, the logging module updates the log that is in relation to the matched encrypted lead. A user interface is in communication with the processor and the network interface to allow a lead provider access to the TPIM server to control his or her private lead information.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system that interfaces with a trusted privacy information manager (TPIM) for lead tracking and providing private lead information control to lead providers.

FIG. 2 is an exemplary block diagram of a TPIM to track leads after being encrypted in one of a variety of ways, in addition to providing access control to lead providers.

FIG. 3 is a flow chart of an exemplary method for tracking and controlling private lead information through a system such as exemplified in FIGS. 1 and 2.

FIG. 4 is a flow chart of a further exemplary method for tracking and controlling private lead information through a system such as exemplified in FIGS. 1 and 2.

### DETAILED DESCRIPTION

In the following description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details.

In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc., that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Pending legislation, if signed into law, is expected to mandate that lead providers must be able to control the flow of their information across the Internet after submission thereof to a publisher or other participant involved in gathering and selling leads online. In other words, the lead provider will be able to retract the lead information from any party that has gained access to the lead. As a consequence, there is a need for a system that can both track to whom the lead has been sold and give a lead provider access to the system to revoke his or her private lead information from a lead consumer. Also envisioned are selective forms of control over the private lead information.

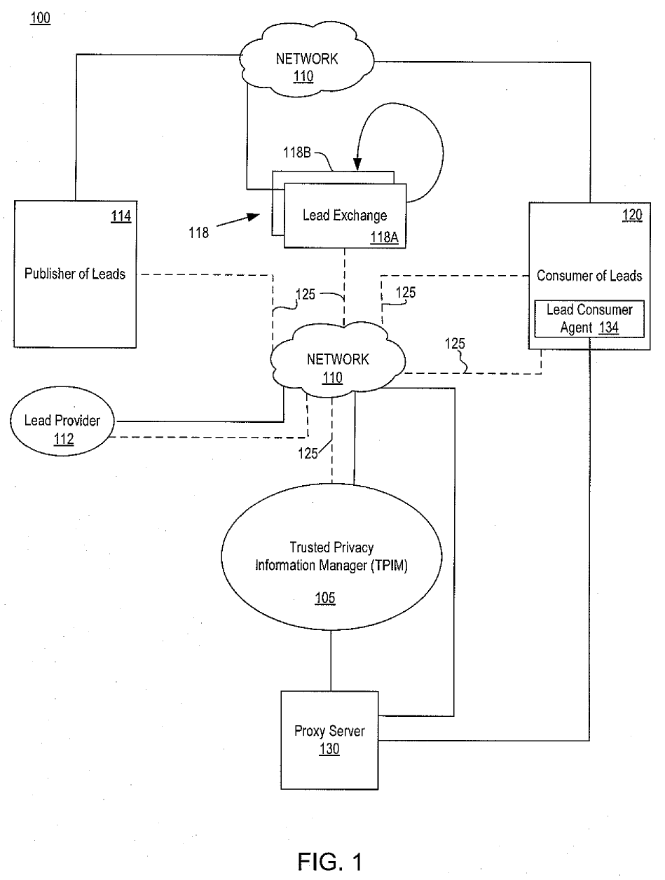

FIG. 1 is a diagram of an exemplary system 100 that interfaces with a trusted privacy information manager (TPIM) 105 to enable lead tracking over a network 110 and to provide control to lead providers 112 of their private lead information after submission over the network 1 10. The network 110 may be the Internet, a local area network (LAN), a wide area network (WAN), or other type of communication network. The system 100 further includes publishers 114 of leads, lead exchanges 118, and lead consumers 120, all which communicate and conduct lead sales over the network 1 10. The dashed lines 125 indicate encrypted communication, which will be discussed in more detail later. Finally, a proxy server 130 is used by the TPIM 105, acting as an intermediary between a lead consumer agent 134 and the lead provider 1 12. Lead consumers 120 are typically entities, but may be a person, and therefore, may be the same as the lead consumer agent 134 as referred to herein.

A new model of online business is evolving in which entities collect and sell personal data in the form of leads, which are indications that identified individuals are, or may be, interested in a marketed good or service. As discussed, leads may be obtained through the Internet or other marketing in which a searcher submits (or otherwise supplies) personal and contact information to sign up for a free or reduced cost good or service, or to make a purchase, among others. Each lead contains at least one item of personal information, the most basic items including a person's name, address, e-mail address, and phone number, but may also include a social security number, a date of birth, and a prior address, etc.

The lead-selling model recognizes that lead information is itself a prized asset and so businesses may exist for the sole purpose of attracting lead providers 112 and collecting personal information submitted to the business, usually through an online submission form. Examples of such businesses are those that service the mortgage, bank, insurance, or automobile industries with potential buyers and that require private details to be provided for the service to be delivered.

Such businesses will be referred to herein generally as the publisher 114 of leads because publishers 114 sometimes publish leads they have generated on the lead exchange 118 so that multiple lead consumers 120 may bid on the leads. Note that lead consumers 120 may also publish to lead exchanges 118, and thereby may be considered both a lead consumer 120 and a lead publisher 114 (or a lead seller) for purposes of this disclosure. Having a bidding process provides the opportunity to drive up prices of the leads through fostering competition, which may increase profits from lead sales. One lead exchange 118A may also republish a lead on a different lead exchange 118B, and lead exchanges 118 exist to serve as an intermediary, or central buying and selling location for leads between publishers 114 and consumers 120. In the alternative, as shown in FIG. 1, publishers 114 may directly sell leads to the lead consumers 120, who may then also publish leads.

Use of this model means individual goods and/or service providers (lead consumers 120) may purchase leads from the publishers 114, thereby obtaining leads without maintaining a separate website for the sole purpose of capturing lead information. Likewise, the consumers 120 do not have to run their own Cost Per Impression (CPM) or Cost Per Click (CPC) advertising campaigns, but need only purchase lead information from one or more Cost Per Lead (CPL) operators, such as a publisher 114 or a lead exchange 118.

The challenge is that both lead exchanges 118 and lead consumers 120 need to be able to verify the quality and freshness of the leads they purchase so as to protect from fraud and rogue CPL operators or publishers 114 (or consumers 120) who may sell the same lead many times or otherwise degrade the value of the lead. The TPIM 105 may, therefore, be integrated within the system 100, wherein all the participants (publishers 114, lead exchanges 118, and lead consumers 120) are required to communicate with the TPIM 105 to report thereto activity associated with the lead. Note that any participant may collect and sell lead information, and therefore, the teachings herein should not be understood to narrow in scope what applies to any given participant as each may play more than one role. Where any one of publishers 114, lead exchanges 118, and lead consumers 120 are referred to, it is for the purpose of identifying the particular role being played by the participant.

The activity history of a lead may be tracked through a log of the TPIM 105 because of such communication, and the activity history may also include the numbers of times the lead has been sold, dates and time stamps of when the lead was purchased or sold, and a status of one or more lead consumers 120 currently working the lead. This allows any consumer 120 to check any lead that he or she may have purchased (or is considering purchasing) against the TPIM 105 logs to see if the lead is fresh, if the lead is likely to have been in circulation for some time, or if it has been over-sold, etc. Tracking the activity history through logs of the TPIM 105 also allows lead providers 112 to access the TPIM 105 for the purposes of learning which lead consumers 120 currently possess their private lead information and the opportunity to control the extent to which one or more lead consumers 120 can use their private lead information.

Furthermore, each transaction of buying or selling leads is a high value transaction, and therefore, susceptible to fraud. The only way to truly consider the TPIM 105 a “trusted” third party entity in the system 100 is to track an encrypted form of the private lead information in lieu of the private lead information itself. Doing so means that the TPIM 105 is never allowed to see or access the actual private lead information; nonetheless, it does provide precise status tracking of leads. A plurality of dashed lines 125 in FIG. 1 indicates paths over which encrypted versions of the private lead information are communicated to the TPIM 105 to track events related to the lead containing private lead information as further explained below.

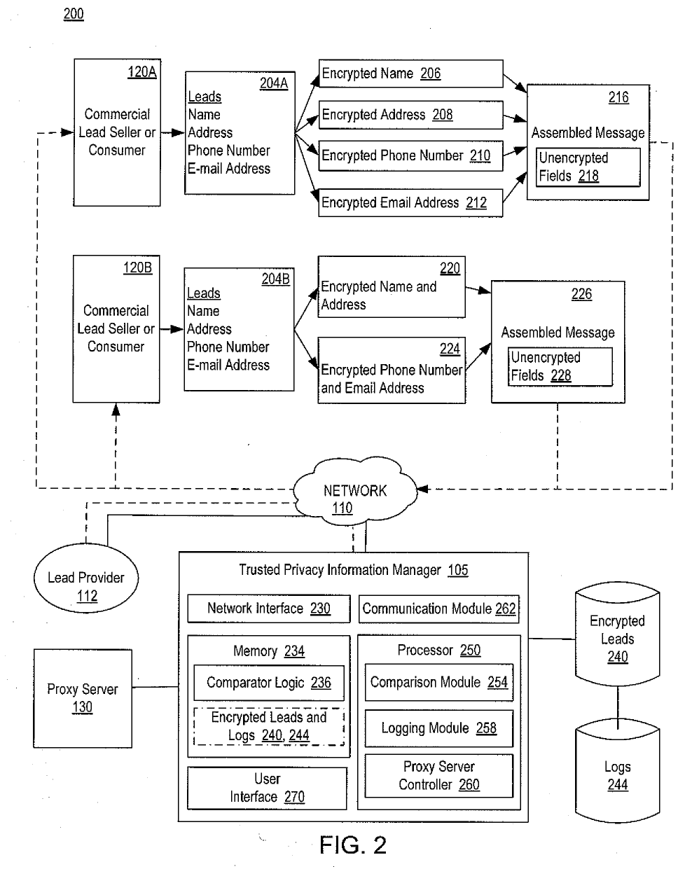

The proxy server 130 may also be provided, which is used by the TPIM 105 to add an additional layer of security, and thus privacy, to the direct contact of lead providers 112 by lead consumer agents 134 who work on behalf of lead consumers 120. In this alternative embodiment, the contact information of a lead provider 112 will be replaced with corresponding contact information stored in the proxy server 130 when supplied to the lead consumers 120. For instance, a proxy phone number or proxy e-mail address corresponding to a lead provider 112 will be supplied to a lead consumer 120 upon purchase of a lead in lieu of the true phone number or true e-mail address of the lead provider 112. The proxy server 130 then allows the lead consumer agent 134 to contact the lead provider 112, for instance, by receiving a phone call as dialed with a proxy phone number, and forwarding that call on to the true phone number of the lead provider 112. Likewise, when the lead consumer agent 134 sends an e-mail to the proxy e-mail address, the proxy server 130 forwards the e-mail on to the true e-mail address of the lead provider 112. The proxy server 130 provides additional security and privacy to lead providers 112 in verifying the identity of a lead consumer agent 134, which will be discussed further with reference to FIG. 2.

FIG. 2 is an exemplary block diagram 200 of a TPIM 105 used to track leads after being encrypted in one of a variety of ways. Any number of one-way hash algorithms, such as Message Digest (MD4 or MD5) or Secure Hash Algorithm (SHA1), may be successfully used so long as the same algorithm is used by all participants in the system 100. A one-way hash algorithm compiles a stream of data into a small digest, e.g. a unique alpha-numeric sequence. Hashing with the algorithm is strictly a one-way operation in that the digest of the clear text data is not meant to be decrypted. Instead, the clear text data is verified through compiling the same clear text data with the same hash algorithm to generate the exact same alpha-numeric sequence or digest. That is, change of one digit of the clear text data may cause a drastic change in the digested version at the output of a one-way hash algorithm, making it easy to determine if the two clear text data streams relate exactly. One-way hash algorithms have been employed for digital signatures, for instance, where the digested signature information may be confirmed.

In FIG. 2, commercial lead consumers 120A, 120B (or sellers) purchase a lead 204A and 204B, respectively, which in this case includes the same kind of information: a name, an address, a phone number, and an e-mail address. In some instances or in some applications, the private lead information may include only some of this information or may include other information. Each piece of private lead information is then pre-processed according to a set of pre-processing rules before encryption to ensure that each data field conforms to predetermined standards that will result in consist results of the one-way hash algorithm. For instance, pre-processing rules may include whether the year is two-digit or four-digit, whether information fields are in all caps, and a standardized way to express phone and social security numbers.

Items of private lead information are then individually encrypted using a one-way hash algorithm as described above to produce a separately encrypted name 206, address 208, phone number 210, and e-mail address 212. The encrypted name 206, address 208, phone number 210, and e-mail address 212 are together assembled into a message 216 containing the lead. The message 216 will also contain a variety of unencrypted fields 218 that may also be passed through the above pre-processing process for consistency. Information in the unencrypted fields 218 may include date and time stamps of when the lead was captured, sold, and/or purchased, the lead type, and a participant identification (ID) (if using an authenticated connection as discussed later) to name just a few. Information in the unencrypted fields 218 will generally be additional log-related information that the TPIM 105 may use to track statuses and statistics of the leads 204A.

In the alternative, multiple items of private lead information may be combined before being encrypted using the one-way hash algorithm. That is, for example, a lead 204B that contains the same type of private information as a different lead 204A may be encrypted so that the name and address 220 are combined and encrypted together, and the phone number and e-mail address 224 are encrypted together. These combinations 220, 224 of encrypted lead information are then assembled into a single message 226 containing the lead. The message 226 may also include a variety of unencrypted fields 228 as discussed previously.

When the TPIM 105 is to be used to also provide access to lead providers 112 so that they may control the use of their private lead information, the e-mail address may also be sent in clear text. This e-mail address may then be used by the TPIM 105 to send a website link or other instructions to a lead provider 112 for accessing the TPIM 105 as discussed below. Also as will be discussed, there are myriad ways for the TPIM 105 to provide access to a lead provider, such as through a client or an application interface.

With further reference to FIG. 2, the details of the TPIM 105 are discussed. The TPIM 105 includes a network interface 230, a memory 234 having comparator logic 236, an encrypted leads database 240, a logs database 244, and a processor 250 having at least a comparison module 254, a logging module 258, and optionally having a proxy server controller 260 in some embodiments. The TPIM 105 also includes a communication module 262 to facilitate communication over the network 110 with the various participants of the system, including lead providers 112. The TPIM 105 finally includes a user interface 270 that allows lead providers 112 to access the TPIM 105 to exercise control over their private lead information, facilitated by the lead tracking of the TPIM 105. To track statuses of the leads 204A, 204B, encrypted messages 216, 226 are passed over the network 110 to the TPIM 105 to be logged therein.

The TPIM 105 includes the network interface 230 to receive, over the network 110, the messages 216, 226 having encrypted lead information 206-212 and 220, 224, respectively, the latter hereinafter variably referred to as “encrypted leads” for convenience. As discussed, the messages 216, 226 also include unencrypted lead information 218, 228, respectively. Despite that the messages 216, 226 contain only a single encrypted lead each as herein described, note that they may contain more than one encrypted lead and, therefore, reference to “encrypted leads” is for ease of explanation only.

The encrypted leads database 240 is used to store the encrypted leads containing items of encrypted lead information 206-212 and 202, 224 along with the unencrypted fields 218, 228 as previously discussed. The log database 244 is provided to store and update a log for the encrypted leads and associated unencrypted fields 218, 228 stored in the encrypted leads database 240. One or more logs are created for, and associated with, each encrypted lead in the log database 244. In an alternative embodiment, a single log may be used to track multiple encrypted leads.

The memory 134 that is also provided includes comparator logic 236, among other software and data, and may additionally include the encrypted leads database 240 and logs database 244 locally in alternative embodiments depending on database size and need for storage flexibility. One of skill in the art will appreciate that databases 240, 244 may be combined into a single database, which may be located locally to, or across the network 110 from, the TPIM 105.

The processor 250 communicates with the memory 234, the databases 240, 244, and the network interface 230 to process and log the received encrypted leads contained in the received messages 216, 226. The comparison module 254 compares newly received encrypted leads with those already stored in the database 240. The logging module 258 logs receipt of the encrypted leads, which may include nothing more than creating a log for a new encrypted lead as the encrypted lead is first stored. If a received encrypted lead matches a stored encrypted lead as determined by the comparison module 254, the log associated with the stored encrypted lead is updated with the receipt information, logged events, and any additional log-related information in the unencrypted fields 218, 228 associated with the matched encrypted lead. For instance, at a minimum, a count is incremented indicating the number of times the lead has been sold, and a date and time stamp from the unencrypted fields 218, 228 is logged to track the freshness of the lead after it has been sold.

A logged event may, therefore, include a variety of information, and the logging module 258 will be required to update a variety of possible fields in a log to be able to track lead statuses. These fields will generally track the possible information sent via the unencrypted fields 218, 228 of the messages 216, 226. The communication module 262 communicates with both the processor 250 and the network interface 230 and sends to any participant requester that has been involved with a lead, a status based on one or more stored logged events and additional unencrypted log-related information received with the lead.

Tracking a log for each lead in the TPIM 105 protects against overselling a lead, which can cause a bad reputation for the lead consumer business as an excessive number of people will follow up on the lead and thus appear to be spamming the lead provider 112. A lead which has been in circulation a long time is stale and can have the same effect. The lead provider 112 seeking the service (like in relation to obtaining a mortgage) is unlikely to appreciate a call several days or weeks after providing details to the publisher 114. It is best if a call is made within 24 hours to the lead provider 112. Such spamming or delay in contact of a lead provider 112 may also convince the lead provider 112 that he or she should investigate the consumers 120 of the lead containing his or her private lead information, and potentially curtail or revoke further use of the private lead information.

Additionally, a lead consumer 120 may spam the TPIM 105 to alter the statistics or statuses tracked therein, which may deter other lead consumers 120 from using the particular lead while the spamming consumer gets sole access to the lead provider. One mechanism to stop this includes requiring each lead consumer 120 to send encrypted leads over an authenticated connection (not shown) that informs the TPIM 105 which consumer 120 (or participant) is sending each message, and the opportunity to remove duplicate submissions before logging status-related information.

To begin a log, ideally the publisher 114 sends fresh encrypted leads to create an initial record of the day and time that the leads were first sold. Note that a consumer 120 may also create the initial log if the publisher 114 did not do so. Each time another participant of the system 100 purchases or sells the lead, that participant is also required to send an encrypted version of the lead, along with any unencrypted fields 218, 228, to the TPIM 105 using the same one-way hash algorithm as used during prior logged events. This requirement creates a trail of purchases of the lead that allows buyers (e.g., lead exchanges 118 or consumers 120) to assess the quality of a lead and sellers to guarantee to prospective buyers a certain level of quality. By also logging who the buyer and seller are (e.g., via the authentication system discussed previously) each time a lead changes hands, the TPIM 105 may provide statuses to other participants that will indicate, based on the reputation of those that handle the lead, whether the other parties can expect the lead to be of quality.

The more sophisticated the logging events logged by the logging module 258, the more useful interaction with the TPIM 105 will be, thereby incentivizing participation in the system 100. For instance, logged events may additionally include recording whether a buyer bought the lead on an exclusive basis or based on a certain number of other buyers. This may be a default logged event if the TPIM 105 receives, for the same lead, more than one indication of a lead sales event within a certain period of time, e.g. a number of hours to a number of days. Further, logged events may include tracking the status of following up with and working a lead, such as whether a lead consumer 120 has contacted the lead, is in negotiations with a lead, has made a sale to, or conversion of, the lead, and whether or not there was some defect in the lead, e.g., an invalid piece of contact information that prevented contact with the lead.

A lead seller may also be able to provide conditions with sold leads such as by setting a period of time that a buyer has an exclusive right to sell a lead, thus minimizing the impact of possible subsequent sales. The seller may also validate the lead is not a duplicate or flag a lead that is already on the market, indicating that it is a duplicate. The seller may also validate that a lead that has a history of already being sold at least once has not been converted, e.g. a sale has not been completed with the lead provider. The seller can also validate through a logged event that a lead is being sold in the location of the address of the lead. These conditions and validations may be logged as individual headers or trailers appended to the lead, such as in the unencrypted fields 218, 228, such that the logging module 258 detects the same and updates the related log in the database 244.

The net result of increasingly sophisticated logged events and protection of the one-way hash algorithm used by the various parties of the system 100 means developing a trusted reputation between buyers and sellers of the system 100. Additional efforts may include prevention of unregistered, unauthenticated, or unauthorized parties from updating the status logs of the TPIM 105 through keeping the one-way hash algorithms secret and requiring confidentiality agreements signed by the parties. The TPIM 105 may also identify potentially fraudulent activity such as through noting discrepancies between compared encrypted leads, which indicates repeated attempts to guess a one-way hash algorithm. The TPIM 105 may also track the ratings of each participant to the system 100 based on a history of disputes, selling duplicates, fraud, or otherwise gaming the system. If any participant abuses the system 100, that party can be blacklisted from TPIM 105 access.

An unencrypted field 218, 228 may also include a lead type, wherein types may be standardized by identifier or name, thus allowing participants to register new lead types. Various conditions may then be associated with certain lead types as standardized by those in that particular industry, for instance by restricting the period of time that a party has to sell a lead before it “expires.”

As discussed previously, an e-mail address of lead providers 112 may be sent in clear text when an encrypted lead is sent for logging at the TPIM 105. In the alternative, other forms of information dissemination with lead providers 112 may be used, such as TELNET, file transfer protocol (FTP) or other transmission control protocol (TCP) connection, instant messaging (I.M.), SMS text messaging, Blackboard®, and the like. Even faxing may be used so long as a way is provided to the TPIM 105 to electronically send information to the lead provider 112 to explain to the lead provider 112 how to access the TPIM 105 for purposes of controlling private lead information.

If an e-mail address is received in clear text, for instance, the TPIM 105 may send an e-mail with a hypertext link, that when clicked by a lead provider 112, will direct the lead provider 112 directly to the user interface 270 of the TPIM 105 through a website on the Internet or an Intranet. In the alternative, the user interface 270 may be interfaced with by a lead provider 112 through a client-side application, or other ways conceivable in the art. Through the user interface 270, the TPIM 105 displays to the lead provider 112 the logged information (or a status based thereon) just as may be provided to any participant of the system 100. This logged information should include at least an identity of the lead consumers 120 currently in possession of private lead information of the lead provider 112. The logged information may further include a purchasing trail of lead consumers 120 that have already sold the lead, yet may continue to possess the private lead information. Thus, the lead provider 112 may ascertain any participant that has come into contact with the lead containing his or her private lead information.

The lead provider 112 may then initiate control over that private lead information via the user interface 270. For instance, the lead provider 112 may select those lead consumers 120 that possess (or have possessed) his or her private lead information that the lead provider 112 would rather that the lead consumers 120 not further use or sell. This may be promoted by circumstances as discussed above where a lead consumer 120 has abused the information, spammed the lead provider, or delayed in contacting the lead provider 112 to the extent the lead provider 112 has moved on, or perhaps purchased from another lead consumer 120.

When the private lead information is controlled, it may be retracted from further use or selling altogether or may be retracted from further specific use or selling. An example of retraction from specific use or selling may be that a publisher 114 or other consumer 120 of leads sells to lead consumers 120 in various industries, e.g. mortgage and banking. Perhaps the lead provider 112 expressed interests in goods or services in more than one of these industries, and now desires to retract from further use private lead information in one or more industries, but not in others. Perhaps also the lead provider 112 desires that his or her private lead information not be further sold by a lead consumer 120, but that it may be further followed up on (or used) by the lead consumer 120. The user interface 270 allows selective retraction in this manner, but when “selective retraction” is referred to herein, it should be construed to mean selective retraction up to and including a full retraction of the private lead information from any lead consumer 120, as full retraction (or no further using or selling of the lead information in general) will always be an option.

The clear text e-mail address, or other form of communication as discussed, may also be used to send to the lead provider 112 information such as a uniform resource locator (URL) that when browsed to by the lead provider 112, supplies access to the user interface 270 of the TPIM 105. Because this URL could be accessed by anyone, the lead provider 112 should first be verified before being allowed to access the full functionality of user interface 270. For instance, a first screen of the URL may accept submission of the same private lead information that was earlier logged by the logging module 258. After the same pre-processing of the private lead information, it is encrypted with the same one-way hash algorithm. The results of the encryption are then compared with stored encrypted leads to verify the lead provider 112, just as a password would do. Once verified, the lead provider is displayed the logged information (or a status based thereon), as discussed previously, and given the opportunity to retract the lead information, selectively or otherwise, from one or more lead consumers 120 as also just discussed.

Retraction of leads or private lead information related thereto may be executed by the TPIM 105 sending a notification as to such through the communication module 262 to the lead consumers 120 as indicated by the lead provider 112. The lead consumers 120 will then need to act on the retraction by not further using and/or selling their information as directed by the notification. Action on the retraction by the lead consumer 120 will either be voluntary as part of an industry code, or will be compelled on the bases of legal obligations as determined through legislation. The TPIM 105 may monitor compliance with the retraction through further logging of activity by the lead consumer 120 from which there was a retraction of private lead information. Sources of monitoring tracking may include other participants sending notifications to the TPIM 105 of non-compliance, thus facilitating policing of the actions of non-compliant lead consumers 120, up to and including being banned as a participant in the system 100.

The proxy server controller 260, as discussed with reference to FIG. 1, may be provided to interface with the proxy server 130, which acts as a communications intermediary between lead consumer agents 134 and lead providers 112. When leads are bought and sold, the only contact information passed to the lead consumers 120 are the proxy phone numbers and e-mail addresses. When a lead consumer agent 134 attempts to call or e-mail a lead provider 112, the lead consumer agent 134 does so with the proxy phone number or the proxy e-mail address provided to the lead consumer agent 134 when the lead consumer 120 purchased the lead. The proxy server 130, as directed by the controller 260, then connects the call, or forwards the e-mail, to the lead provider 112 at a corresponding actual phone number or e-mail address stored in the proxy server 130. In this way, the TPIM 105 is interjected into the process and thus may also validate or verify lead consumer agents 134 that try to the contact lead providers 112.

Verification occurs by requiring lead consumer agents 134 to register with the TPIM 105 upon corresponding lead consumers 120 becoming a participant in the system 100. In the alternative, a lead consumer agent 134 could register when submitting an encrypted lead for logging. In registration, lead consumer agents 134 may provide, among other information, their own phone number and e-mail address; likewise, the communications module 262 may detect an internet protocol (I.P.) address of the lead consumer agent 134. The TPIM 105 may, in turn, provide each registering lead consumer agent 134 a personal identification number (PIN) that may be used for verification as well. This verification information is then associated with a purchased lead when a lead consumer agent 134 logs the lead through the TPIM 105.

Then, when communication with a lead provider 112 is attempted, the proxy server controller 260 compares at least one of stored I.P. addresses, e-mail addresses, phone numbers, and PINs of lead consumer agents 134 with information detected or provided by the lead consumer agent 134 attempting the communication. Upon finding a match, the identity of the lead consumer agent 134 is verified as being associated with the lead of the lead provider 112. Once this verification is complete, the call is connected or the e-mail forwarded to the lead provider 112.

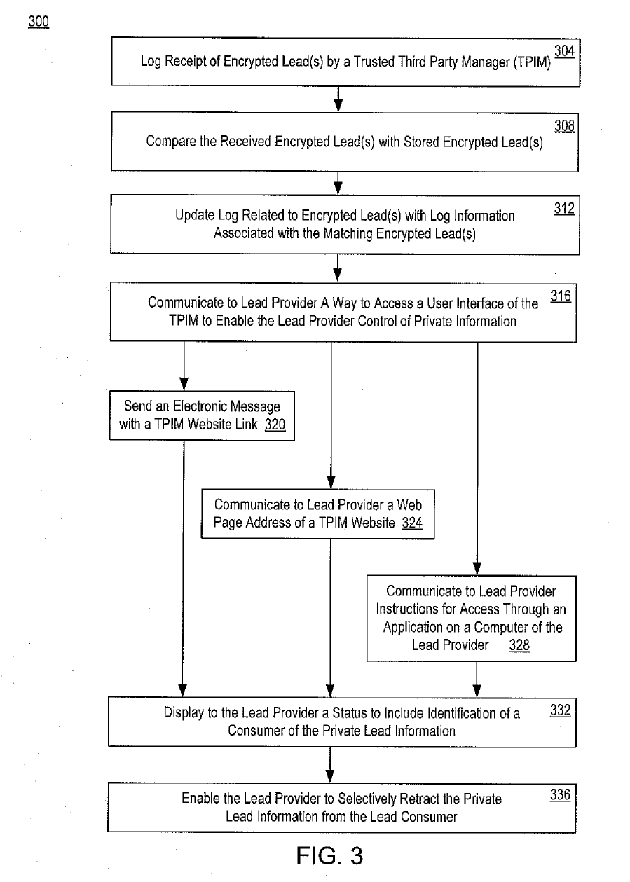

FIG. 3 is a flow chart 300 of an exemplary method for tracking and controlling private lead information through a system such as exemplified in FIGS. 1 and 2. At step 304, a trusted privacy information manager (TPIM) 105 logs receipt of one or more encrypted leads as received from a participant thereof. The one or more leads include private lead information from a lead provider 112 having been pre-processed and encrypted with a one-way hash algorithm. At step 308, the TPIM 105 compares the received one or more encrypted leads with stored encrypted leads to find any matches. At step 312, the TPIM 105 updates the log related to the one or more encrypted leads with log information associated with the matching one or more encrypted leads. The log information includes at least one of an e-mail address and a phone number of the lead provider 112. At step 316, the TPIM 105 communicates to the lead provider 112 at least one way to access a user interface 270 of the TPIM 105 that enables the lead provider 112 to control his or her private lead information.

Steps 320, 324, and 328 include a number of possible methods the TPIM 105 may employ to communicate to a lead provider 112 ways to access a user interface 270 to control the private lead information of the latter. At step 320, the TPIM 105 may send an electronic message with a TPIM website link, that when clicked, will take the lead provider 112 to a web page that provides access to the user interface 270. At 324, the TPIM 105 may communicate to a lead provider 112 a web page address of a TPIM website, that when browsed to, verifies the identity of the lead provider 112 through execution of the one-way hash algorithm on pre-processed private lead information as originally supplied to the TPIM 105. Once verified, the lead provider 112 gains access to the TPIM website as in step 320. At step 328, the TPIM 105 communicates to the lead provider 112 instructions for access to the user interface 270 through an application on a computer of the lead provider 112.

At step 332, after gaining access to the user interface 270, the TPIM 105 displays to the lead provider 112 a status of the private lead information based on the log, including at least an identification of a lead consumer 120 that possesses, or has possessed, the private lead information. At step 336, while at the web page or application, the lead provider 112 may also selectively retract the private lead information from the lead consumer 120 as discussed previously.

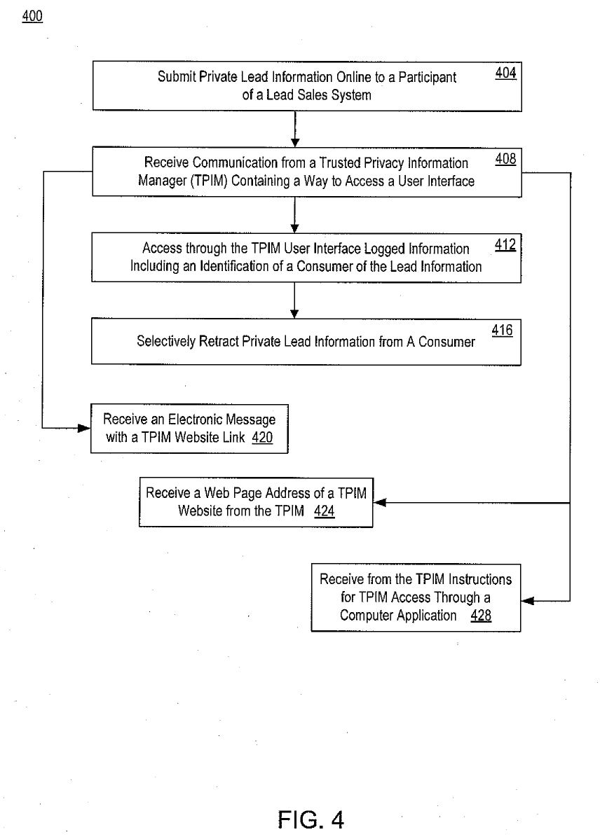

FIG. 4 is a flow chart 400 of a further exemplary method for tracking and controlling private lead information through a system such as exemplified in FIGS. 1 and 2. At step 404, a lead provider 112 submits lead information online to a participant of the lead sales system. At step 408, the lead provider 112 receives a communication from a trusted privacy information manager (TPIM) 105 containing at least one way to access a user interface 270 of the TPIM 105. At step 412, the lead provider 112 accesses, through the TPIM user interface 270, logged information gathered by the TPIM 105, which includes at least an identification of a consumer that possesses, or has possessed, the private lead information. At step 416, the lead provider 112 selectively retracts the private lead information from the consumer.

Steps 420, 424, and 428 include a number of possible ways in which the lead provider 112 may communicate with the TPIM 105 to access the user interface 270 to control the private lead information. At step 420, the lead provider 112 receives a website link through an e-mail message that, when clicked, directs a browser of the lead provider 112 to a TPIM website. At step 424, the lead provider receives a web page address from the TPIM 105 corresponding to a TPIM website, that when browsed to, verifies the identity of the lead provider 112 through execution of the one-way hash algorithm on private lead information as originally supplied to the TPIM 105. Once verified, the lead provider 112 gains access to the TPIM website as in step 420. At step 428, the lead provider 112 receives instructions from the TPIM 105 for access to the user interface 270 through an application on a computer of the lead provider 112.

While specific embodiments and applications of various methods and systems for conducting experiments over the Internet have been illustrated and described, it is to be understood that the disclosure claimed herein is not limited to the precise configuration and components disclosed. Various modifications, changes, and variations apparent to those of skill in the art may be made in the arrangement, operation, and details of the methods and systems disclosed.

The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

What is claimed is:

1. A method for tracking and controlling privacy information within a lead sales system, comprising:
logging receipt in a log of one or more encrypted leads by a trusted privacy information manager (TPIM) that are received from a participant thereof, the one or more leads including private lead information from a lead provider having been pre-processed and encrypted with a one-way hash algorithm;
comparing the received one or more encrypted leads with stored encrypted leads to find any matches;
updating the log related to the one or more encrypted leads with log information associated with the matching one or more encrypted leads, wherein the log information includes at least one of an e-mail address and a phone number of the lead provider; and
communicating to the lead provider at least one way to access a user interface of the TPIM that enables the lead provider to control his or her private lead information.

2. The method of claim 1, wherein the at least one way to access the user interface comprises sending an electronic message with a TPIM website link, and upon clicking the website link, further comprising:
displaying to the lead provider in a web browser a status of the private lead information based on the log, which status includes at least an identification of a lead consumer that possesses, or has possessed, the private lead information; and
enabling the lead provider to selectively retract the private lead information from the lead consumer.

3. The method of claim 2, wherein enabling the lead provider to selectively retract the private lead information comprises sending a notification through the TPIM to the lead consumer to not further at least one of use and sell the private lead information.

4. The method of claim 2, further comprising:
monitoring compliance by the lead consumer with the selective retraction of the private lead information.

5. The method of claim 1, wherein the way to access the user interface comprises communicating to the lead provider a web page address of a TPIM website, and upon the lead provider browsing to the web page address, further comprising:
accepting submission of the same private lead information through a browser of the lead provider;
pre-processing and encrypting the private lead information with the same one-way hash algorithm;
comparing the results of the one-way hash algorithm with a stored encrypted lead to verify the identity of the lead provider;
displaying to the verified lead provider a status of the private lead information based on a related log, which status includes at least an identification of a lead consumer that possesses, or has possessed, the private lead information; and
enabling the lead provider to selectively retract the private lead information from the lead consumer.

6. The method of claim 5, wherein enabling the lead provider to selectively retract the private lead information comprises sending a notification through the TPIM to the lead consumer to not further at least one of use and sell the private lead information.

7. (canceled)

8. The method of claim 1, further comprising:
enabling a lead consumer agent to contact the lead provider through at least one of a proxy e-mail address and a proxy phone number provided by a proxy server interface with the TPIM.

9. The method of claim 8, further comprising:
verifying, before forwarding a call or an e-mail to the lead provider, an identity of the lead consumer agent through at least one of comparing an e-mail address and comparing an internet protocol (I.P.) address with, respectively, an e-mail address and an I.P. address stored when the lead consumer agent registered with the TPIM.

10. The method of claim 8, further comprising:
verifying, before forwarding a call or an e-mail to the lead provider, an identity of the lead consumer agent through at least one of comparing a phone number and an issued personal identification number (PIN) with, respectively, a phone number submitted by, and a PIN issued to, the lead consumer agent that were stored when the lead consumer agent registered with the TPIM.

11. The method of claim 1, wherein the participant of the lead clearing house comprises at least one of a publisher, the lead provider, a lead exchange, and a lead consumer, the method further comprising:
communicating a status to the participant based on the log relating to the one or more leads.

12. The method of claim 1, wherein the at least one way to access the TPIM user interface comprises providing instructions to the lead provider to complete the access through an application installed on a computer of the lead provider that communicates over a network with the TPIM user interface.

13. A method for tracking and controlling privacy information within a lead sales system, comprising:
submitting private lead information online by a lead provider to a participant of the lead sales system;
receiving a communication from a trusted privacy information manager (TPIM) containing at least one way to access a user interface of the TPIM;
accessing, through the TPIM user interface, logged information gathered by the TPIM, which includes at least an identification of a consumer that possesses, or has possessed, the private lead information; and
selectively retracting the private lead information from the consumer.

14. The method of claim 13, wherein the at least one way to access the TPIM user interface comprises receiving a website link through an e-mail message that, when clicked, directs a browser of the lead provider to a TPIM website.

15. The method of claim 13, wherein the at least one way to access the TPIM user interface comprises receiving a web page address corresponding to a TPIM website, further comprising:
browsing to the TPIM website at the web page address;
logging on to the TPIM; and
submitting the private lead information through the TPIM website to be verified by encryption with a one-way hash algorithm before gaining access.

16. The method of claim 13, wherein selectively retracting the private lead information comprises sending a notification through the TPIM to the lead consumer to at least one of stop using and selling the private lead information, the method further comprising:
checking on the status of compliance with the selective retraction of the private lead information as monitored by the TPIM.

17. A trusted privacy information management (TPIM) server for tracking sales leads, comprising:
a network interface, to receive over a network, messages comprising private lead information pre-processed and encrypted with a one-way hash algorithm, each message comprising at least one encrypted lead and unencrypted log information;
a memory to store the encrypted leads together with a log in relation to each encrypted lead;
a processor in communication with the memory and the network interface, the processor operative in conjunction with stored data and instructions to implement:
a comparison module to compare received encrypted leads with stored encrypted leads;
a logging module to log receipt of the encrypted leads along with the associated log information, and if an encrypted lead has a match, to update the log that is in relation to the matched encrypted lead; and
a user interface in communication with the processor and the network interface to allow a lead provider access to the TPIM server to control his or her private lead information.

18. The TPIM server of claim 17, further comprising:
a communications module in communication with the processor and the network interface to send to a participant a status of the at least one encrypted lead based on the log related thereto, wherein the participant is registered with the TPIM server.

19. The TPIM server of claim 18, wherein the communications module sends at least one of an e-mail or an SMS text message to the lead provider with a TPIM website link, which when clicked, the processor:
displays to the lead provider through the user interface the status of the private lead information based on the log, which status includes at least an identification of a lead consumer that possesses, or has possessed, the private lead information; and
enables the lead provider to selectively retract the private lead information from the lead consumer.

20. The TPIM server of claim 19, wherein to enable the lead provider to selectively retract the private lead information, the processor, through the communication module, sends a notification to the lead consumer to not further at least one of use and sell the private lead information.

21. The TPIM server of claim 19, wherein the logging module monitors compliance by the lead consumer with the selective retraction of the private lead information, and includes progress with such compliance in the log related to the retracted lead.

22. The TPIM server of claim 18, wherein the communication module sends a web page address to the lead provider, which when browsed to online by the lead provider, the processor:
accepts submission of the same private lead information through a browser of the lead provider;
pre-processes and encrypts the private lead information with the same one-way hash algorithm;
compares the results of the one-way hash algorithm with a stored encrypted lead to verify the identity of the lead provider;
displays to the verified lead provider through the user interface the status of the private lead information based on a related log, which status includes at least an identification of a lead consumer that possesses, or has possessed, the private lead information; and
enables the lead provider to selectively retract the private lead information from the lead consumer.

23. (canceled)

24. The TPIM server of claim 22, wherein the event logging module monitors compliance by the lead consumer with the retraction of the private lead information, and includes progress with such compliance in the log related to the retracted lead.

25. The TPIM server of claim 17, further comprising:
a proxy server interfaced with by the TPIM, wherein the processor allows, through the proxy server, a lead consumer agent to contact the lead provider through at least one of a proxy e-mail address and a proxy phone number provided to the lead consumer agent by the proxy server.

26. The TPIM server of claim 25, wherein the processor further comprises a proxy server controller that, before forwarding a call or an e-mail to the lead provider, verifies an identity of the lead consumer agent through at least one of comparing an e-mail address and comparing an internet protocol (IP) address with, respectively, an e-mail address and an IP address stored when the lead consumer agent registered with the TPIM server.

27. The TPIM server of claim 25, wherein the processor further comprises a proxy server controller that, before forwarding a call or an e-mail to the lead provider, verifies an identity of the lead consumer agent through at least one of comparing a phone number and a personal identification number (PIN) with, respectively, a phone number submitted by, and a PIN issued to, the lead consumer agent that were stored when the lead consumer agent registered with the TPIM server.
